(19) United States
(12) Patent Application Publication
(10) Pub. No.: US 2011/0146858 A1
(43) Pub. Date: Jun. 23, 2011

(54) PROTECTIVE COVER FOR GOGGLES

(76) Inventor: Jeffrey B. PARKS, Livingston, MT (US)

(21) Appl. No.: 12/641,485

(22) Filed: Dec. 18, 2009

(51) Int. Cl. B65D 65/02; B23P 17/04

(52) U.S. Cl. 150/154; 29/428

(57) ABSTRACT

A protective cover for goggles is described. The protective cover comprises three elements: a first fabric piece for covering the front part of a pair of goggles in a goggle assembly; a second fabric piece joined to the first fabric piece for further enveloping the rest of the goggle assembly, and an elastic band installed in the second fabric piece in a channel for securing the protective cover to the goggle assembly.

### BACKGROUND

Skiers, snowboarders, snow-mobilers and others who are outdoors for extended periods of time often use goggles to provide protection from the sun's UV and to shield their eyes from potential damage due to their activities. When not in use over their eyes, the goggles may be relocated over their foreheads, or put into a pocket or pouch, in which case there is a need to protect the goggles from scratching or other types of damage. This application describes an invention for providing the protection.

### BRIEF DESCRIPTION OF THE DRAWINGS

The accompanying drawings, which are incorporated in and form a part of this application, illustrate various embodiments of the presented technology, and together with the description of embodiments, serve to explain the principles of the presented technology. Unless noted, the drawings referred to this description should be understood as not being drawn to scale.

FIG. 1 is a pictorial view of an embodiment of the invention.

FIG. 2 is a template displaying an embodiment of the invention.

FIG. 3A-D displays the components of the protective cover in accordance with an embodiment.

FIG. 3F-H displays assembly steps for assembling an embodiment of the invention.

FIG. 4 is a flowchart of a method for manufacturing a protective cover for goggles in accordance with embodiments of the present technology.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope as defined by the appended claims. Furthermore, in the following description, numerous specific details are set forth in order to provide a thorough understanding of the subject matter. In other instances, well-known methods, procedures, objects, and circuits have not been described in detail as not to unnecessarily obscure aspects of the subject matter.

### Notation and Nomenclature

Unless specifically stated otherwise as apparent from the following discussions, it is appreciated that throughout the present Description of Embodiments, discussions utilizing terms such as fabric, material, fiber, woven, element, component, piece, joining method, sewn, sewing, glued, gluing, and the like are common terms associated with the manufacture and assembly of fabric-based products.

Herein is described a protective cover for a pair of goggles, comprising a first fabric piece configured to substantially cover the goggles, and having an outer edge, a second fabric piece having a cylindrical surface with a first edge and a second edge, wherein the first edge of the second fabric piece is joined to the outer edge of the first fabric piece via a connection mechanism, and has an elastic band joined to the outer edge of the second fabric piece via a second connection mechanism. In an embodiment, the first fabric piece consists of a neoprene material and has a first fabric pattern and color. Neoprene has superior protection properties. One manufacturer, Dupont Chemicals, cites the following features (www.dupontelastomers.com/products/neoprene/neoprene.asp); resists degradation from sun, ozone and weather, performs well in contact with oils and many chemicals, remains useful over a wide temperature range, displays outstanding physical toughness, resists burning inherently better than exclusively hydrocarbon rubbers, and outstanding resistance to damage caused by flexing and twisting.

In an embodiment, the second fabric piece consists of a lycra material, and has a second fabric pattern and color. Lycra is a trade name for a synthetic elastane fiber, also known as spandex, and is always blended with other fibers. The U.S Federal Trade Commission defines spandex as the generic name for the elastic fiber category, but the names have become interchangeable. Therefore reference to Lycra herein means the same item or material as spandex. Lycra-based fabrics are lightweight and strong, and are widely used in sportswear such as swim suits, ski suits, and many other garments including shirts and sweaters. Lycra can be stretched to several times its original size, but still retains its shape upon release from the stretching. It is particularly attractive in moisture-rich environments such as encountered in skiing and snowboarding because of is its ability to wick away moisture and let it evaporate from the fabric.

In an embodiment, the second fabric piece is configured to form a cylindrical shape that is attached to the first fabric piece, and extends fabric assembly so that the fabric assembly covers the goggle assembly, namely the lenses and the frame holding the lenses.

In an embodiment, the elastic band secures the entire fabric assembly of the first piece and the second piece by captivating the fabric assembly behind the frame holding the goggle lenses. It should be appreciated that the elastic band may be either sewn to the outer edge of the second piece of fabric, glued on, encapsulated, or attached using other well known techniques for fastening fabric. The elastic band is stretched and then attached so that when it contracts back to its rest shape, the second fabric material is constricted to a smaller circumferential length, thus providing a means for holding the entire fabric assembly tightly around the back side of the goggles, and keeping the first piece of fabric snugly fit against the goggle lenses.

### DETAILED DESCRIPTION

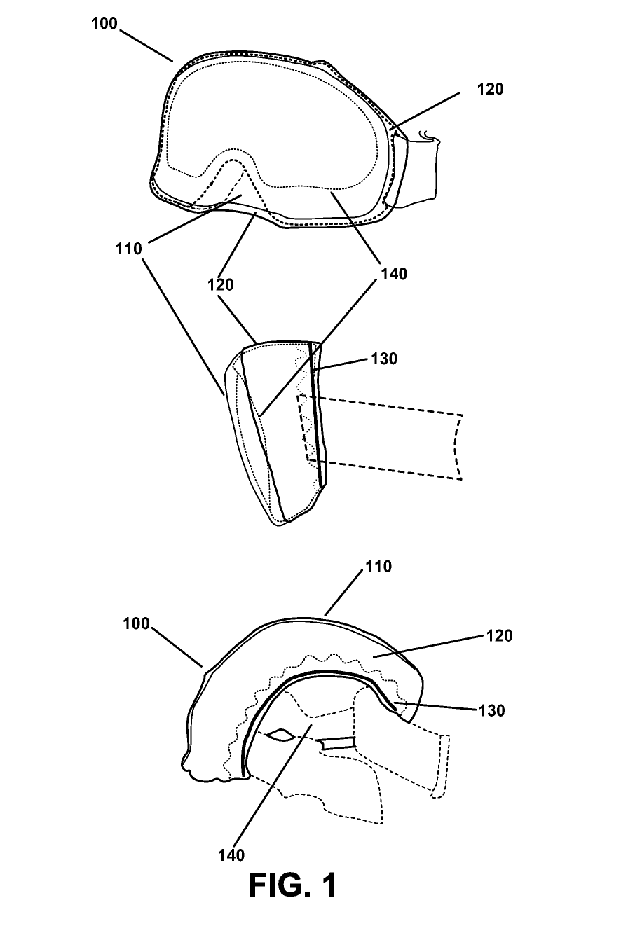

The protective cover is shown in FIG. 1 at 100. The goggles are shown in dotted line at 140. The protective cover consists of three parts: a first fabric piece that provides protection for the goggle lenses and frame, shown at 110; a second fabric piece formed in the general shape of a cylinder, shown at 120; and an elastic band for providing a snug fit and retaining the entire fabric assembly on the goggles, shown at 130.

In an embodiment, the first fabric piece is made from a flat piece of appropriate fabric material, and is rectangular but with rounded ends, to match the general shape of the lens/goggle frame. In an embodiment, the first fabric is made using Neoprene, which has very desirable features for protecting a goggle assembly. Other suitable materials are also appropriate, including spandex-based materials.

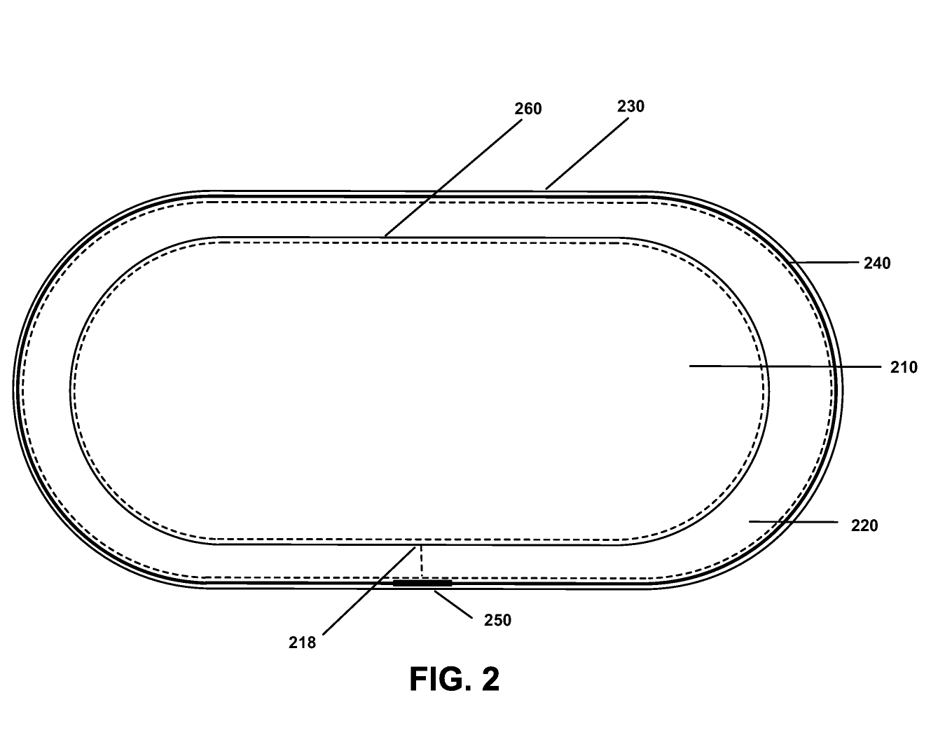

A detailed view of the assembly 200 of the three components is shown in FIG. 2. The front cover for the lens is referred to as the first fabric piece at 210. The second fabric piece is shown at 220. This piece 220 forms an extension for the first fabric piece 210, and serves as the base to which the elastic band shown at 240 is joined. This base 220 has an outer edge at 230. The other edge is at 260 and is referred to as the first edge of the second piece of fabric. A ferrule 250 is used to secure the ends of the elastic band 240 to prevent unraveling from wear and use.

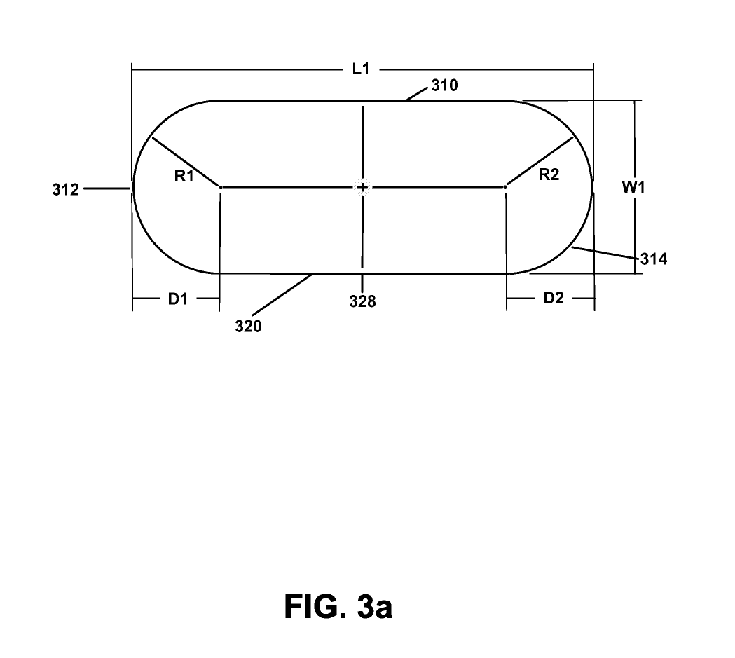

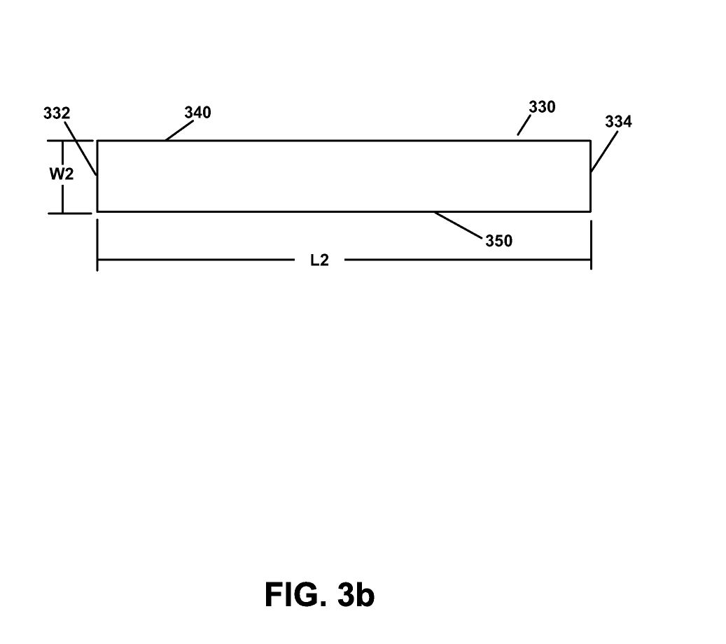

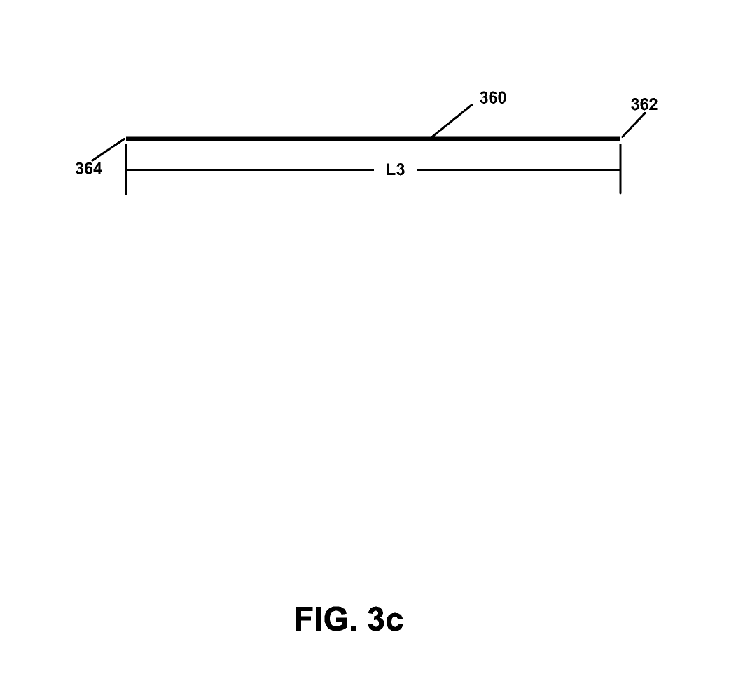

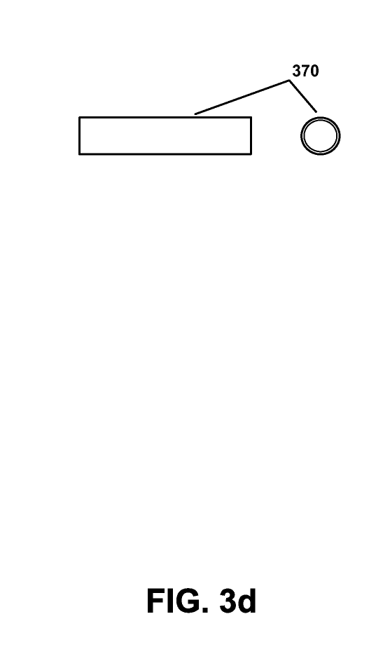

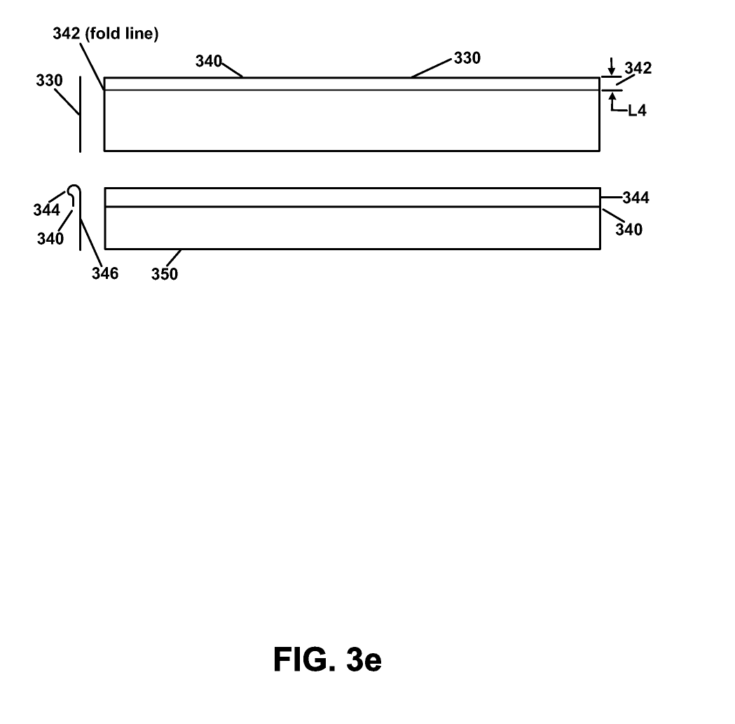

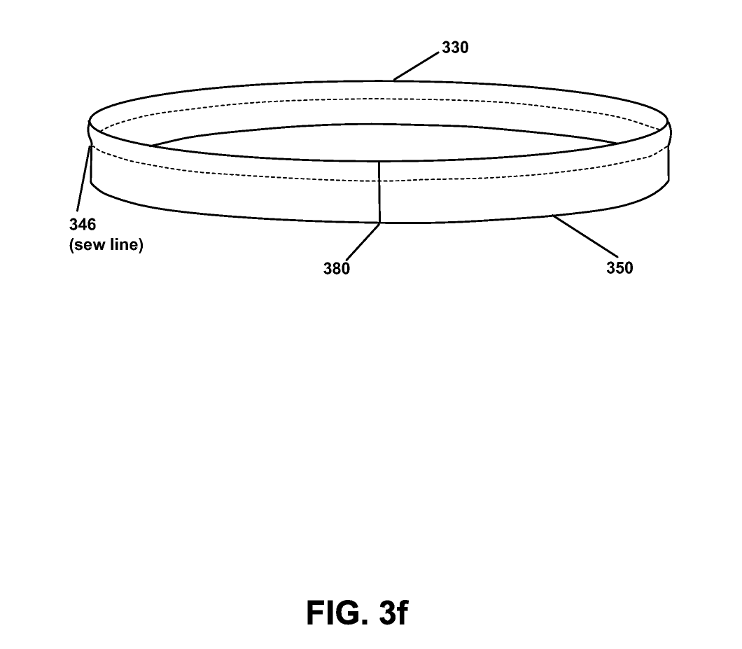

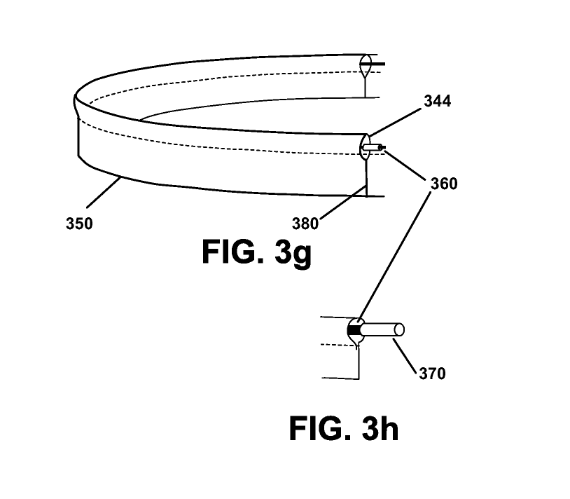

The dimensions for an embodiment of the three components of the protective cover assembly are shown in FIGS. 3A, 3B, 3C, and 3D. In an embodiment, the first fabric piece 310 shown at FIG. 3A has dimensions W1=4.5 inches and L1=9 inches, with half-circle shaped ends at 312 and 314, each with a radius R1 and R2 of 2.25 inches, with center of the circle located at D1=D2 dimension of 2.25 inches from either curved edge 312 and 314. The outer edge is at 320 and is the same as the outer edge in FIG. 2 at 230 and refers to the entire periphery of the first fabric piece 310.

As shown in FIG. 3B, in an embodiment the second fabric piece 330 comprises a flat piece of appropriate material cut into a rectangular shape with dimensions of L2 inches by W2 inches. In an embodiment L2=17 inches and W2=2.75 inches. The narrow ends 332 and 334 of the second fabric piece 330 are joined together, via a connection mechanism such as by sewing on a sewing machine or by gluing with a glue gun, forming a joint 380, as shown in subsequent FIG. 3F. In this manner, the joined ends 332 and 334 of the second fabric piece 330 now form the second fabric piece 330 into a loop.

As shown in FIG. 3B, one of the edges of the second fabric piece 330 is selected to be the first edge at 350, and is joined to the outer edge 320 of the first fabric piece 310 via a connection mechanism, such as by sewing on a sewing machine or gluing with a glue gun. In an embodiment, the joint 380 formed by connecting the narrow edges 332 and 334 of the second fabric piece 330 are located so that the joint 380 is aligned at a midpoint of the length of the first fabric piece 310, as shown in FIG. 2 at 218? and again in FIG. 3A at 328.

As shown in FIG. 3B, the remaining outer edge 340 of the second piece of fabric 330, is where the elastic band 360 is attached.

As shown in FIG. 3C, the elastic band 360 has a length L3. In an embodiment L3=14 inches.

A ferrule 370 is used to join the 2 ends of the elastic band 360 together. The ferrule 370 is shown in FIG. 3D. The ferrule 370 is typically manufactured from a single piece of metal, rolled to form an partially closed cylinder, so that the ferrule 370 can be installed over the elastic band 360; then the ferrule 370 is crimped to a closed or more nearly closed configuration via an appropriate tool such as a pair of pliers specifically configured to match the shape and size of the ferrule. This step in the assembly process can be done either before or after the two ends 332 and 334 of the second fabric piece 330 are joined together, as explained further below.

Assembly of the various components making up the protective cover are shown in FIG. 3E-H. In an embodiment, a channel 344 is formed to hold the elastic band. This channel 344 is formed by folding a portion of the top edge 340 along it long side at a depth shown at 342, whose dimension L4 is approximately 0.50 inch top edge 340 now forms the base of the channel 344, and is sewn together along the long side of the second fabric piece 330. Alternatively, the top edge 340 may be joined to the appropriate point along the second fabric piece via a gluing process. For example, a circular cross-section mandrel or rod may be used to create the appropriate-sized loop diameter, and the joint between the top edge 340 and the seam edge 346, shown in FIG. 3E, may be formed by either sewing or gluing.

The second fabric piece 330 is formed into a loop by joining the two ends 332 and 334 together, either by sewing or gluing.

The elastic band 360 is threaded through the channel 344 and the two ends 362 and 364 of the elastic band 360 are joined together with the ferrule 370. The ferrule 370 is crimped using well-known crimping techniques and tools.

In an embodiment, this step of joining the ends of second fabric piece 330 may be joined together first, leaving the channel 344 open, so that the elastic band 360 may be threaded through the channel 344, and then joined together with the ferrule 370.

The second fabric piece 330 is then joined to the first fabric piece 310 by joining the outer edge 320 of the first fabric piece 310 to the inner edge (second edge) 350 of the second fabric piece 330. In an embodiment, the step of joining may comprise sewing the two pieces of fabric together, or gluing them together.

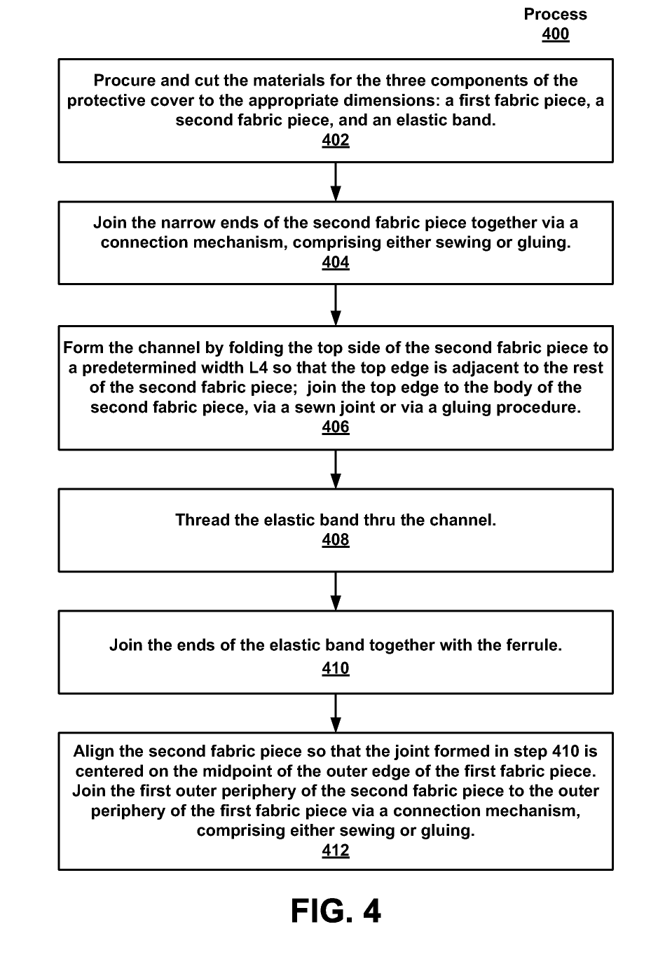

With reference now to FIG. 4, a flowchart for manufacturing a protective cover. FIG. 4 depicts process 400. It should be appreciated that steps in the manufacture of the protective cover may be carried out using some or all of the steps shown in process 400. It should also be appreciated that the steps described below reference components depicted in FIGS. 3A-H. The steps of process 400 describe an order of steps for purposes of the disclosure; the order below should not be construed to limit the present technology. In various embodiments of the present technology, some or all of the steps of process 400 may be used.

At 402, procure and cut the materials for the three components of the protective cover to the appropriate dimensions: the first fabric piece 310, the second fabric piece 330, the elastic band 360.

At 404, join the narrow ends 332 and 334 of second fabric piece 330 together via a connection mechanism, comprising either sewing or gluing.

At 406, form the channel 344 by folding the top side 340 of the second fabric piece 330 a predetermined width L4 so that the top edge 340 is adjacent to the rest of the second fabric piece; join the top edge 340 to the body of the second fabric piece 330, via a sewn joint or via a gluing procedure.

At 408, thread the elastic band 360 thru the channel 344.

At 410, join the ends 362 and 364 of the elastic band 360 together with the ferrule 370.

At 412, align the second fabric piece 330 so that the joint formed in step 5 is centered on the midpoint 328 of the outer edge 320 of the first fabric piece 310. Join the first outer periphery 350 of the second fabric piece 330 to the outer periphery 320 of the first fabric piece 310 via a connection mechanism, comprising either sewing or gluing.

In an embodiment, Step 406 may be done before Step 404 above with no loss in generality.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims. Additionally, in various embodiments of the present technology, the steps and methods described herein do not need to be carried out in the order specified, nor do all steps need to be carried out to accomplish the purposes of the technology.

What is claimed is:

1. A protective cover for goggles, comprising
a first fabric piece configured to substantially cover a pair of goggles, and having a first outer edge;
a second fabric piece having a cylindrical surface with a first edge and a second edge, wherein the first edge of the second fabric piece is joined to the outer edge of said first fabric piece via a first connection mechanism; and
an elastic band wherein the elastic band is joined to the outer edge of the second fabric piece via a second connection mechanism.

2. The protective cover of claim 1 wherein the second fabric piece comprises a flat sheet of fabric having a pair of two opposing edges, wherein one pair of the opposing edges are joined together via a third connection mechanism.

3. The protective cover of claim 1 wherein the first connection mechanism is a sewn joint.

4. The protective cover of claim 1 wherein the first connection mechanism is glued joint.

5. The protective cover of claim 1 wherein the second connection mechanism is a sewn joint.

6. The protective cover of claim 1 wherein the second connection mechanism is a glued joint.

7. The protective cover of claim 2 wherein the third connection mechanism comprises a sewn joint.

8. The protective cover of claim 2 wherein the third connection mechanism comprises a glued joint.

9. The protective cover of claim 1 wherein the first fabric piece is consists of neoprene.

10. The protective cover of claim 1 wherein the second fabric piece consists of spandex.

11. A protective cover for goggles, comprising
a fabric assembly configured to substantially cover a pair of goggles, and having a proximal outer edge;
an elastic band joined to the proximal outer edge of the fabric assembly, wherein the elastic band provides a retention mechanism configured to retain the fabric assembly on the goggles.

12. The protective cover of claim 11 wherein the fabric assembly further comprises:
a first fabric piece having a first outer edge and configured to substantially cover the front face and outer periphery of the goggles; and
a second fabric piece forming a cylindrical surface with a first edge and a second edge, wherein the first edge of the second fabric piece is joined to the first outer edge of said first fabric piece via a first connection mechanism.

13. The protective cover of claim 12 wherein the first connection mechanism comprises a sewn joint.

14. The protective cover of claim 12 wherein the first connection mechanism comprises a glued joint.

15. The protective cover of claim 12 wherein the first fabric piece consists of neoprene.

16. The protective cover of claim 12 wherein the second fabric piece consists of spandex.

17. The protective cover of claim 12 wherein the second fabric piece consists of a single sheet with two pairs of opposing edges, wherein one pair of the opposing edges are joined together via a second connection mechanism to form the cylindrical fabric piece.

18. The protective cover of claim 17 wherein the second connection mechanism comprises a sewn joint.

19. The protective cover of claim 17 wherein the second connection mechanism comprises a glued joint.

20. The protective cover of claim 11 wherein the elastic band is joined to the proximal outer edge of the fabric assembly via a sewn joint.

21. The protective cover of claim 11 wherein the elastic band is joined to the proximal outer edge of the fabric assembly via a glued joint.

22. A method for making a protective cover for goggles, comprising the steps of:
providing a first fabric piece having an outer edge and configured to substantially cover the face and outer periphery of a pair of goggles;
providing a second fabric piece forming a cylindrical surface and having a first edge and a second edge, and configured to extend the outer edge of the first fabric piece by a predetermined distance;
joining the outer edge of the first fabric piece to the first edge of the second fabric piece via a first connection mechanism; and
providing an elastic band and joining the elastic band to the second edge of the second fabric piece via a second connection mechanism.

23. The method of claim 22 wherein the second fabric piece is formed from a flat piece having two pairs of opposing sides, and one pair of the opposing sides are joined together via a third connection mechanism, forming a cylindrical surface.

24. The method of claim 22 wherein the step of providing a first fabric piece consists of providing a neoprene material.

25. The method of claim 22 wherein the step of providing a second fabric piece consists of providing a spandex material.
